(19) United States
(12) Patent Application Publication
(10) Pub. No.: US 2009/0276616 A1
(43) Pub. Date: Nov. 5, 2009

(54) SERVO DEVICE AND METHOD OF SHARED BASIC INPUT/OUTPUT SYSTEM

(75) Inventors: Chao-Jen WANG, Taipei (TW); Hsing-Ying LEE, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/164,558

(22) Filed: Jun. 30, 2008

(30) Foreign Application Priority Data
May 2, 2008 (TW) 097116253

(51) Int. Cl. G06F 15/177

(52) U.S. Cl. 713/2

(57) ABSTRACT

A servo device and method of a shared basic input/output system (BIOS) include a plurality of mainboards, a circuit board, and a switching control unit. When a disk boot failure event of the mainboard occurs, a transmission path is conducted between the mainboard where the disk boot failure event occurs and a memory unit of another mainboard according to a control signal generated by the switching control unit in response to the disk boot failure event of the mainboard, such that the mainboard shares the BIOS.

### CROSS-REFERENCE TO RELATED APPLICATIONS

This non-provisional application claims priority under 35 U.S.C. § 119(a) on Patent Application No(s). 097116253 filed in Taiwan, R.O.C. on May 2, 2008 the entire contents of which are hereby incorporated by reference.

### BACKGROUND OF THE INVENTION

1. Field of Invention

The present invention relates to a servo device, in particularly, to a servo device of a shared basic input/output system (BIOS).

2. Related Art

A common personal computer (PC) cannot be operated by multiple users at the same time. Therefore, a computer capable of supporting multiple users at the same time and having high computation ability has been developed, which is named server. The server is operated by multiple clients over network.

In recent years, the server system has been advanced into a stage of blade server system, which is not only space-saving, but also adapted to be used in offices of enterprises, thus meeting the requirements for economic benefits. The blade server system integrates multiple mainboards into one casing through a complete pedestal.

A basic input/output system (BIOS) is the most basic firmware program codes stored in the computer hardware, and mainly used for Power-On Self Test (POST), initialization, recording system settings, providing a routine library, and loading an operating system. The BIOS is a micro operating system in communication with the hardware.

In a blade server system, each of the mainboards is equipped with a Read Only Memory (ROM), so as to store the BIOS used for booting.

However, if the BIOS in any one of the mainboards in the blade server system is damaged, the mainboard cannot be normally booted. Furthermore, if the BIOS is damaged, the maintenance is quite complicated and costs a lot of time no matter the BIOS is replaced by the user, or sent back to the manufacturer of the blade server system for maintenance.

### SUMMARY OF THE INVENTION

In order to solve the problems in the prior art, the present invention provides a servo device and method of a shared BIOS, so as to solve the problem in the prior art that a computer cannot be booted when a BIOS of a mainboard in a blade server system is damaged.

The servo device of a shared BIOS provided by the present invention includes a plurality of mainboards, a circuit board, and a switching control unit.

Each of the mainboards is electrically connected to the circuit board. The switching control unit is disposed on the circuit board.

Each of the mainboards includes a memory unit, a chip set, and a path switching unit. The memory unit is electrically connected to the path switching unit. The path switching unit is electrically connected to the chip set.

The memory unit stores at least one BIOS. The path switching unit has a transmission path communicating the BIOS with the switching control unit.

When a mainboard is booted, a chip set therein receives the BIOS of the memory unit through the path switching unit. When the BIOS stored in a memory unit of the mainboard of the chip set is damaged, in response to the disk boot failure event of the mainboard, the switching control unit generates a control signal to the mainboard where the disk boot failure event occurs and another mainboard except the mainboard where the disk boot failure event occurs. The path switching units of the mainboards receive the control signal and conduct the transmission path according to the control signal. In response to the disk boot failure event of a mainboard, the switching control unit generates the control signal to the two mainboards according to a use state of the BIOS by the other mainboard.

Furthermore, a management unit is further disposed on the circuit board. The management unit is electrically connected to the switching control unit. The management unit detects the disk boot failure events of all the mainboards and enables the switching control unit when the disk boot failure event occurs.

Then, each mainboard is further provided with a substrate management control unit. The substrate management control unit is electrically connected to the management unit. When the disk boot failure event occurs, the substrate management control unit reports the disk boot failure event of the mainboard to the management unit.

In an embodiment of the present invention, the path switching unit may include a timing unit and a switch. Each chip set includes a general purpose input/output (GPIO) and a serial peripheral interface control unit.

The timing unit calculates the receiving time of the BIOS so as to generate a switching signal when reaching the receiving time. The switch conducts the transmission path communicating with the switching control unit according to the control unit and cuts off the transmission path communicating with the switching control unit according to the switching signal.

The management unit acquires the use state of the BIOS by the mainboard through the GPIO. The serial peripheral interface control unit receives the BIOS through the path switching unit.

In view of the above, by the use of the servo device of the shared BIOS provided by the present invention, when the disk boot failure event of a mainboard occurs, the path switching unit conducts a transmission path between the mainboard where the disk boot failure event occurs and a memory unit of another mainboard according to the control signal generated by the switching control unit in response to the disk boot failure event of the mainboard, such that that the mainboards may share the BIOS.

### BRIEF DESCRIPTION OF THE DRAWINGS

The present invention will become more fully understood from the detailed description given herein below for illustration only, and thus are not limitative of the present invention, and wherein:

FIG. 1 is a block diagram of the servo device of a shared BIOS according to an embodiment of the present invention;

FIG. 2 is a block diagram of the servo device of a shared BIOS according to an embodiment of the present invention;

FIG. 3 is a block diagram of a servo device of a shared BIOS according to an embodiment of the present invention; and

FIG. 4 is a flow chart of using the shared BIOS according to an embodiment of the present invention.

### DETAILED DESCRIPTION OF THE INVENTION

In a servo device of a shared BIOS provided by the present invention, a path switching unit is used to conduct a transmission path between the mainboard where the disk boot failure event occurs and a memory unit of another mainboard according to the control signal generated by the switching control unit in response to the disk boot failure event of the mainboard, such that the mainboards may share the BIOS.

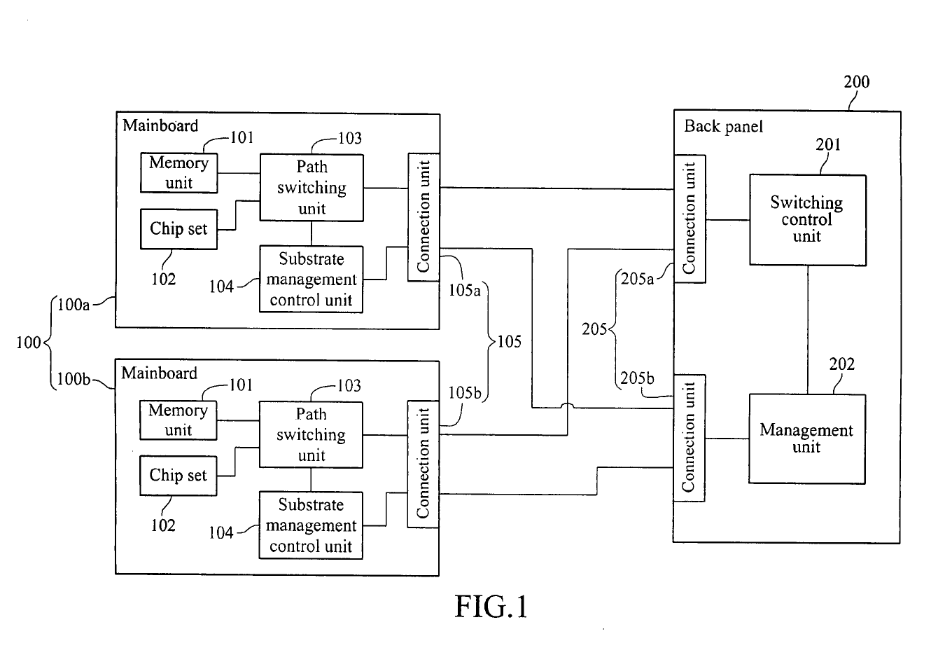

FIG. 1 is a block diagram of a servo device of a shared BIOS according to an embodiment of the present invention. Referring to FIG. 1, the servo device of the shared BIOS includes a plurality of mainboards 100, a circuit board (for example, a back panel 200), and a switching control unit 201. For convenience of illustration, for example, two mainboards i.e., a first mainboard 100a and a second mainboard 100b which may also be called mainboards 100 in general are provided in this embodiment, but the present invention is not limited to this. Furthermore, for example, the circuit board is, for example, the back panel 200.

Each mainboard 100 is electrically connected to the back panel 200. The switching control unit 201 is disposed on the back panel 200.

Each mainboard 100 includes a memory unit 101, a chip set 102, and a path switching unit 103. The memory unit 101 is electrically connected to the path switching unit 103. The path switching unit 103 is electrically connected to the chip set 102.

The memory unit 101 stores at least one BIOS.

The path switching unit 103 has a transmission path communicating the BIOS with the switching control unit 201.

When the mainboard 100 is booted, the chip set 102 therein receives the BIOS of the memory unit 101 through the path switching unit 103. When the BIOS of the memory unit 101 of the mainboard 100 having the chip set 102 is damaged, the switching control unit 201, in response to the disk boot failure event of the mainboard 100, generates a control signal to the mainboard 100 where the disk boot failure event occurs and another mainboard 100 except the mainboard 100 where the disk boot failure event occurs. The path switching units 103 of the mainboards 100 receiving the control signal conduct the transmission path according to the control signal.

The switching control unit 201, in response to the disk boot failure event of the mainboard 100, generates the control signal to the two mainboards 100 according to a use state of the BIOS by another mainboard 100.

For example, when the BIOS stored in the memory unit of the first mainboard 100a is damaged, the switching control unit 201 on the back panel 200 generates a control signal to the first mainboard 100a and the second mainboard 100b in response to the disk boot failure event of the first mainboard 100a. Then, the path switching unit 103 of the first mainboard 100a and the path switching unit 103 of the second mainboard 100b conduct the transmission path according to the control signal generated by the switching control unit 201. After the transmission paths of the first mainboard 100a and the second mainboard 100b are conducted, the chip set 102 of the first mainboard 100a acquires the BIOS in the memory unit 101 of the second mainboard 100b through the path switching unit 103 of the first mainboard 100a, the switching control unit 201 on the back panel 200, and the path switching unit 103 of the second mainboard 100b, so as to execute the boot programs accordingly.

Furthermore, a management unit 202 is further disposed on the back panel 200, and the management unit 202 is electrically connected to the switching control unit 201.

The management unit 202 detects the disk boot failure events of all the mainboards 100 and enables the switching control unit 201 when the disk boot failure event occurs.

Furthermore, each mainboard 100 is further provided with a substrate management control unit 104. The substrate management control unit 104 is electrically connected to the management unit 202.

When the disk boot failure event occurs, the substrate management control unit 104 reports the disk boot failure event of the mainboard 100 to the management unit 202.

Furthermore, the servo device of the shared BIOS further includes a plurality of connection units 105a, 105b, 205a, 205b (referred to as “connection units 105, 205” hereinafter).

The first mainboard 100a and the second mainboard 100b respectively have connection units 105a and 105b, and the connection units 205a and 205b are disposed on the back panel 200. The connection unit 105a corresponds to the connection unit 205a, so as to be coupled to each other to form a communication path between the first mainboard 100a and back panel 20. Likewise, the connection unit 105b corresponds to the connection unit 205b, so as to be coupled to each other to form a communication path between the second mainboard 100b and the back panel 200.

Here, all the elements on the back panel 200 communicate with the elements of the mainboard 100 through a corresponding group of connection units 205 and 105. The corresponding connection units 105 and 205 may be an interface and a slot in the form of golden fingers respectively. The mainboard 100 is inserted into the corresponding slot on the back panel 200 via the golden finger interface, so as to form the communication between the mainboard 100 and the back panel 200. However, the corresponding connection units 105 and 205 may also be two bus headers, so as to form communication between the mainboard 100 and the back panel 200 through the two headers connected by the bus.

Furthermore, the communication between the back panel 200 and a mainboard 100 is achieved by a group of the connection units 105, 205, as well as two or more groups of the connection units 105, 205.

Herein, the switching control unit 201 (and the management unit 202) may be optionally realized with a single processor. In other words, the function of the switching control unit 201 (and the management unit 202) may be achieved by hardware elements, or firmware/software. The memory unit 101 may selectively use the ROM. However, the aforementioned description is merely used for illustration instead of limiting the present invention.

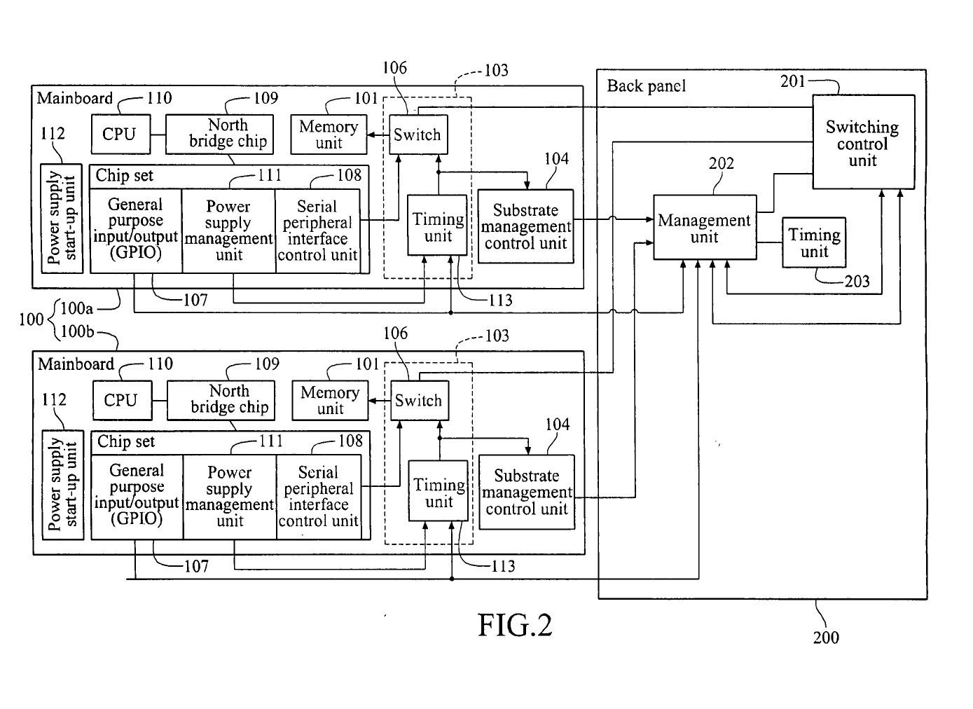

FIG. 2 is a block diagram of a servo device of a shared BIOS according to an embodiment of the present invention. Referring to FIG. 2, according to this embodiment, the path switching unit 103 includes a timing unit 113 and a switch 106. The chip set 102 includes a general purpose input/output (GPIO) 107, a serial peripheral interface control unit 108, and a power supply management unit 111. The mainboard 100 also includes a power supply start-up unit 112.

The timing unit 113 of the path switching unit 103 calculates the receiving time of the BIOS and generates a switching signal when reaching the receiving time. The switch 106 conducts the transmission path communicating with the switching control unit 201 according to the control signal and cuts off the transmission path communicating with the switching control unit 201 according to the switching signal.

The management unit 202 acquires a use state of the BIOS by the mainboard 100 through the GPIO 107. The serial peripheral interface control unit 108 receives the BIOS through the path switching unit 103. The power supply management unit 111 confirms whether the power supply of the mainboard 100 is started up. The power supply start-up unit 112 may be used for booting.

The back panel 200 is further provided with a timing unit 203, and the timing unit 203 of the back panel 200 is electrically connected to the management unit 202, so as to calculate the time for the path switching unit 103 that receives the control signal of the mainboard 100 to conduct the transmission path according to the control signal.

In this embodiment, the chip set 102 may be a south bridge chip. The mainboard 100 further includes a north bridge chip 109 and a CPU 110, so as to execute computer instruction calculation. The south bridge chip (i.e., the chip set 102) is electrically connected to the north bridge chip 109. The north bridge chip 109 is electrically connected to the CPU. Basically, the operating principles of the south bridge chip, the north bridge chip, and the CPU are well-known to those skilled in the art, and will not be described here. Furthermore, the south bridge chip and the north bridge chip may also be implemented by an integrated chip. However, aforementioned description is merely used for illustration instead of limiting the implementation aspects of the present invention.

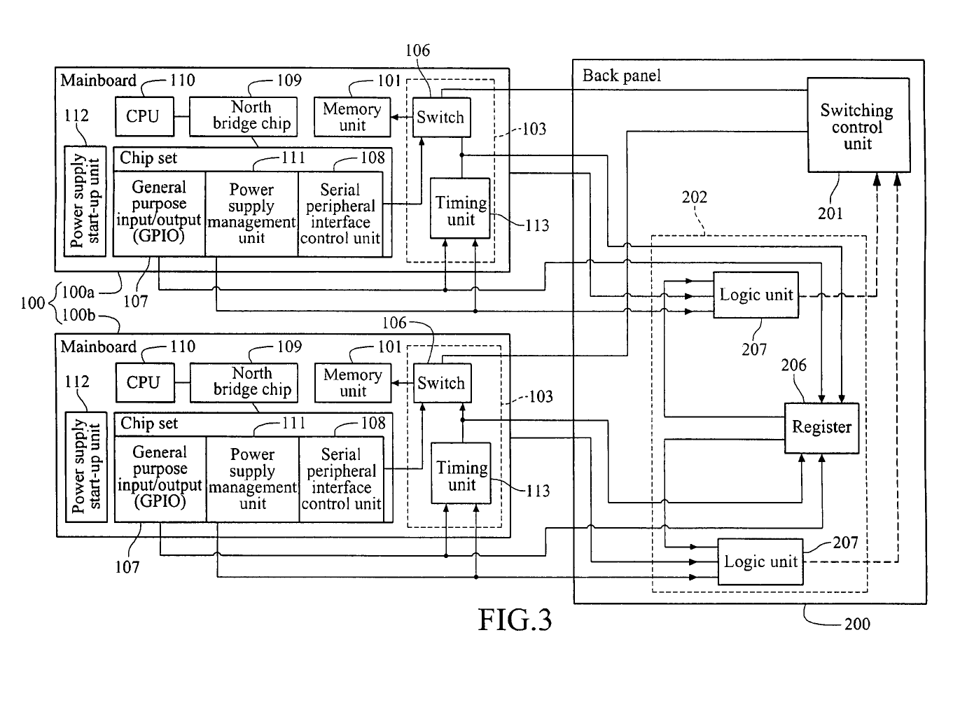

FIG. 3 is a block diagram of the servo device of a shared BIOS according to an embodiment of the present invention. Referring to FIG. 3, the management unit 202 of this embodiment includes a register 206 and a plurality of logic units 207.

The register 206 is electrically connected to the logic units 207 and the chip set 102. The logic units 207 are electrically connected to the mainboard 100 and the switching control unit 201.

The register 206 records a use state of the transmission path by the mainboard 100. Each logic unit 207 generates an enable signal and a switching signal according to the disk boot failure event of one of the mainboards 100 and the records of the register 206 in one of the mainboards 100. The switching signal is used to switch the records of the register 206.

When the mainboard 100 has no transmission path, the register 206 outputs an idle signal to each of the logic units 207, and the logic units 207 outputs the enable signal and the switching signal when receiving the disk boot failure event and the idle signal.

Here, the logic units 207 may be an AND gate selectively, which is merely used for exemplary illustration.

For example, when the mainboard 100 has no transmission path, the register 206 records the idle state of logic “0” (i.e., a use state) and outputs the idle signal of the logic “0” to the AND gate (i.e., the logic units 207). After receiving the disk boot failure event of the logic “1” and the idle signal of the logic “0,” the AND gate outputs the enable signal of the logic “1” and the switching signal of the logic “1,”. such that the register 206 record a busy state of the logic “1” (i.e., another use state), thereby acquiring that the use state of the transmission path is a busy state.

Generally speaking, each mainboard 100 has respective model (also called “mainboard model”).

Here, the switching control unit 201 sequentially conducts the transmission paths between each of the mainboards 100 and the mainboard 100 where the disk boot failure event occurs, till the mainboard 100 where the disk boot failure event occurs acquires the BIOS of another mainboard 100 and successfully execute the boot programs by the use of the acquired BIOS.

Furthermore, the memory unit 101 also stores a plurality of BIOSes, and each BIOS corresponds to one mainboard model. The memory unit 101 also stores a single BIOS shared program segment and a plurality of BIOS entity program segments. Each BIOS entity program segment corresponds to one mainboard model. In other words, one of the BIOS shared program segment and the BIOS entity program segments constitute a BIOS corresponding to one mainboard model. In booting, the single BIOS shared program segment is provided for each mainboard to use sequentially. According to the corresponding mainboard model, the BIOS entity program segment is provided for the mainboard with the mainboard model to use.

When the disk boot failure event of the mainboard 100 occurs, according to the model of the mainboard 100 where the disk boot failure event occurs, the switching control unit 201 conducts the transmission path between another mainboard 100 with the same model and the mainboard 100 where the disk boot failure event occurs according to the model of the mainboard 100 where the disk boot failure event occurs, acquires the corresponding BIOS from the memory unit 101 of the another mainboard 100, and transmits the BIOS to the mainboard 100 where the disk boot failure event occurs.

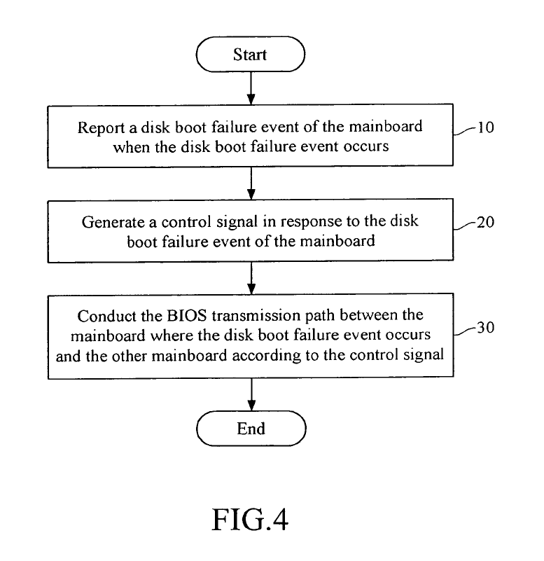

FIG. 4 is a flow chart of using the shared BIOS according to an embodiment of the present invention.

First, when a disk boot failure event of a mainboard 100 occurs, the substrate management control unit 104 reports the disk boot failure event of the mainboard to the management unit 202 of the back panel 200 (Step 10). Then, after the management unit 202 sends the information of the mainboard where the disk boot failure event occurs to the switching control unit 201, the switching control unit 201 generates a control signal in response to the disk boot failure event of the mainboard 100 (Step 20). Finally, the BIOS transmission path between the mainboard 100 where the disk boot failure event occurs and the other mainboard 100 is conducted according to the control signal (Step 30).

For convenience of illustration, for example, two mainboards are illustrated. Referring to FIGS. 2 and 4, the mainboards may be a first mainboard 100a, a second mainboard 100b, and a back panel 200 are shown. The BIOS stored in the second mainboard 100b includes a plurality of entity program segments corresponding to one model. Here, the model of the second mainboard 100b is corresponding to the model of the first mainboard 100a.

First, the first mainboard 100a starts up the booting program through pressing a power switch. At this time, the chip set 102 of the first mainboard 100a outputs a booting signal of logic “1” to the timing unit 113 of the path switching unit 103 of the first mainboard 100a. Then, the timing unit 113 starts timing and the switch 106 of the path switching unit 103 conducts the first path between the chip set 102 of the first mainboard 100a and the memory unit 101 of the first mainboard 100a, and executes the booting program. When the disk boot failure event of the first mainboard 100a occurs, the timing unit 113 stops timing and outputs a switching signal of logic “1” to the switch 106. The switch 106 cuts off the first path and switches to a second path. At this time, the substrate management control unit 104 of the first mainboard 100a outputs a disk boot failure signal of the first mainboard 100a to the management unit 202 of the back panel 200 (Step 10). The management unit 202 orders the timing unit 203 of the back panel 200 to start timing, and outputs the model of the first mainboard 100a to the switching control unit 201. Then, the switching control unit 201 generates a control signal (Step 20) and conducts the second path and the path switching unit 103 of the second mainboard 100b according to the control signal, such that the chip set 102 of the first mainboard 100a may receive the BIOS in the memory unit 101 of the second mainboard 100b corresponding to the model of the first mainboard 100a (Step 30). Finally, the first mainboard 100a executes the booting program for the second time. After the booting program has been executed completely, the chip set 102 of the first mainboard 100a outputs a disk boot success signal of logic “1” to the management unit 202, so as to make the timing unit 203 of the back panel 200 stop timing.

In view of the above, by the use of the servo device of a shared BIOS provided by the present invention, when a disk boot failure event of a mainboard occurs, the path switching unit conducts a transmission path between the mainboard where the disk boot failure event occurs and a memory unit of another mainboard according to the control signal generated by the switching control unit in response to the disk boot failure event of the mainboard, such that the mainboards may share the BIOS.

What is claimed is:

1. A servo device of a shared basic input/output system (BIOS), comprising:
a plurality of mainboards, each comprising:
a memory unit, for storing at least one BIOS; and
a chip set, for receiving the BIOS when the mainboard where it belongs is booted;
a circuit board, electrically connected to each of the mainboards; and
a switching control unit, disposed on the circuit board, for generating a control signal to the two mainboards among the mainboards in response to a disk boot failure event of the mainboard, the two mainboards comprising the mainboard where the disk boot failure event occurs;
wherein each of the mainboards further comprises:
a path switching unit, electrically connected to the chip set and the memory unit, and having a transmission path communicating the BIOS with the switching control unit, so as to conduct the transmission path according to the control signal.

2. The servo device of a shared BIOS according to claim 1, further comprising:
a management unit, disposed on the circuit board and electrically connected to the switching control unit, so as to detect the disk boot failure event of each mainboard and enable the switching control unit when the disk boot failure event occurs.

3. The servo device of a shared BIOS according to claim 2, wherein each of the mainboards comprises:
a substrate management control unit, electrically connected to the management unit, for reporting the disk boot failure event of the mainboard to the management unit.

4. The servo device of a shared BIOS according to claim 1, wherein each of the path switching units comprises:
a timing unit, for calculating a receiving time of the BIOS, so as to generate a switching signal when reaching the receiving time; and
a switch, for conducting the transmission path according to the control signal, and cutting off the transmission path according to the switching signal.

5. The servo device of a shared BIOS according to claim 1, wherein each of the mainboards further comprises:
a substrate management control unit, for reporting the disk boot failure event of the mainboard where it belongs.

6. The servo device of a shared BIOS according to claim 1, wherein in response to the disk boot failure event of one of the two mainboards, the switching control unit generates the control signal according to a use state of the BIOS by another mainboard of the two mainboards.

7. The servo device of a shared BIOS according to claim 6, further comprising:
a management unit, disposed on the circuit board and electrically connected to the switching control unit, so as to detect the disk boot failure event of each mainboard and confirming the use state of the BIOS by the mainboard, and enable the switching control unit according to the use state when the disk boot failure event occurs.

8. The servo device of a shared BIOS according to claim 7, wherein each of the chip sets comprises:
a general purpose input/output (GPIO), through which the management unit acquires the use state of the BIOS by the mainboard where it belongs; and
a serial peripheral interface control unit, electrically connected to the path switching unit, so as to receive the BIOS.

9. A servo device of a shared BIOS, comprising:
a first mainboard, comprising:
a memory unit, for storing at least one BIOS; and
a chip set, for receiving the BIOS when the first mainboard is booted;
a second mainboard, comprising:
a memory unit, for storing at least one BIOS; and
a chip set, for receiving the BIOS when the second mainboard where it belongs is booted;
a circuit board, electrically connected to the first mainboard and the second mainboard; and
a switching control unit, disposed on the circuit board, for generating a control signal in response to a disk boot failure event of the first mainboard;
wherein each of the first mainboard and the second mainboard further comprises:
a path switching unit, electrically connecting to the chip set and the memory unit, and having a transmission path communicating the BIOS with the switching control unit, so as to conduct the transmission path according to the control signal;
wherein when the path switching unit conducts the transmission path, the BIOS in the second mainboard is transmitted between the second mainboard and the first mainboard through the transmission path.

10. The servo device of a shared BIOS according to claim 9, wherein each of the mainboards further comprises:
a management unit, disposed on the circuit board and electrically connected to the switching control unit, so as to detect the disk boot failure event of each mainboard and enable the switching control unit when the disk boot failure event occurs.

11. The servo device of a shared BIOS according to claim 10, wherein the management unit comprises:
a register, for recording a use state of the BIOS by the mainboard; and
a plurality of logic units, each generating an enable signal and a switching signal according to the disk boot failure event of one of the mainboards and the records of the register, wherein the switching signal is used to switch the records of the register.

12. The servo device of a shared BIOS according to claim 9, wherein each of the path switching units comprises:
a timing unit, for calculating a receiving time of the BIOS, so as to generate a switching signal when reaching the receiving time; and
a switch, for conducting the transmission path according to the control signal, and cutting off the transmission path according to the switching signal.

13. The servo device of a shared BIOS according to claim 10, wherein each of the chip sets comprises:
a general purpose input/output (GPIO), through which the management unit acquires the use state of the BIOS by the mainboard where it belongs; and
a serial peripheral interface control unit, electrically connected to the path switching unit, so as to receive the BIOS.

14. The servo device of a shared BIOS according to claim 10, wherein the BIOS stored in the second mainboard comprises a plurality of entity program segments corresponding to a model, and when the path switching unit conducts the transmission path, the switching control unit captures an entity program segment corresponding to the model of the first mainboard from the memory unit of the second mainboard according to the model of the first mainboard and transmits the entity program segment to the first mainboard.

15. A servo method of a shared BIOS, applied in a servo device, wherein the servo device comprises a plurality of mainboards and a circuit board, each of the mainboards stores a BIOS, and a transmission path is provided between every two mainboards, the method comprising:
reporting a disk boot failure event of the mainboard to the circuit board when the disk boot failure event occurs;
in response to the disk boot failure event, generating a control signal through the circuit board; and
according to the control signal, conducting the transmission path between the mainboard where the disk boot failure event occurs and another mainboard, so as to share the BIOS.
